(19) United States
(12) Patent Application Publication
(10) Pub. No.: US 2007/0277598 A1
(43) Pub. Date: Dec. 6, 2007

(54) PENETROMETER WITH ELECTRONICALLY-CONTROLLED HAMMERING MODULE

(76) Inventors: Krzysztof A. Zacny, Emeryville, CA (US); David Glaser, Berkeley, CA (US)

Correspondence Address: Leighton K. Chong;IP & Patent Attorney, 133 Kaai Street, Honolulu, HI, 96821, US

(21) Appl. No.: 11/756,604

(22) Filed: May 31, 2007

Related U.S. Application Data
(60) Provisional application No. 60/804,076, filed on Jun. 6, 2006.

(51) Int. Cl. G01N 3/40; E02D 1/00

(52) U.S. Cl. 73/84

(57) ABSTRACT

An electronically-controlled hammering module is used to apply a repetitive hammering force under electronic control to the top end of a dynamic cone penetrometer rod. In a preferred embodiment, the hammering module has a battery-powered percussive hammer that applies an electrically-generated impulse hammering force to the top of the rod. The depth of penetration is measured with a range-finder and used to compute the rate of penetration of the rod into the ground and correlated to the strength of the soil. The rate of hammering is controlled to cause the rod to penetrate into the soil at a controlled rate correlated with the strength of the soil.

This U.S. patent application claims the priority of U.S. Provisional Application No. 60/804076 filed on Jun. 6, 2006, entitled “Percussive Cone Penetrometer and Accelerated Cone Penetrometer”, of the same inventors.

The subject matter herein was developed for ERDC as part of the “Rapid In-Situ Soil Characterisation System”, funded through the Department of Defense SBIR Phase I program. The U.S. Government retains certain rights in the invention.

### TECHNICAL FIELD

This invention relates to an improved penetrometer device for applying a hammering impulse force to drive a rod into the ground to a desired level.

### BACKGROUND OF INVENTION

A penetrometer is used for performing soil strength measurements in the field. The measurements obtained can be correlated with the engineering soil strength parameter such as the California Bearing Ratio (CBR), a widely accepted standard in civil engineering, or possibly with a physical soil strength parameter, such as a soil bearing strength. Soil strength measurements are used in the construction of paved and unpaved roads, airfields, and building foundations.

As an example of a prior device, a dynamic cone penetrometer (DCP) is described in U.S. Pat. No. 5,313,825, issued May 24, 1994, for performing soil strength measurement making use of a sliding hammer (one of two different weights) that is manually lifted and dropped onto a steel rod having a cone-shaped point. Each time the hammer is dropped, the rod penetrates deeper into the soil. The depth of penetration is measured with an integrated ruler and this data is later converted to an index that is then correlated to the CBR. The Dual-Mass DCP measurement meets the industry standards of ASTM D6951.

Prior devices also include an automated dynamic cone penetrometer (ADCP) which employs the same cone rod and hammer as the DCP device, but, in place of a human operator, a mechanism is used to automatically lift and drop the DCP hammer. The entire device is heavy and must be mounted on a trailer or other wheeled vehicle.

The disadvantages of the prior art are many. For the DCP device, repeated manual lifting of the sliding hammer causes fatigue on the part of the human operator (which in turn reduces the accuracy of the measurement because tired operator doe not lift the hammer all the way to the top) and/or requires multiple operators to avoid fatigue. Operators frequently injure themselves by getting pinched by the sliding hammer. Operators also require hearing protection because individual hammer blows are very noisy. The quality of the measurements is compromised by operator error in manually taking the depth measurements, particularly in cases where fatigue has set in. The measured data needs to be manually typed into the spreadsheet to obtain the CBR. This extra information makes the process more time consuming. The lighter of the two standard hammers is intended for use with weaker soils. However, operators without proper training may not be able to identify when the smaller hammer should be used. Furthermore, changing from one hammer to another is cumbersome and time consuming. Also, for extremely weak soils, the lighter hammer is still too heavy to produce the best possible results. The pressure wave developed in the device may also break the braze between the rod and the hammer assembly making the device useless.

For the ADCP device, the main disadvantage is the large size and mass of the unit. It must be mounted on a trailer or a small truck and this restricts the locations where it can be used. It also has the same disadvantages as the DCP device with regard to changing hammers and providing accurate measurements in very weak soils.

### SUMMARY OF INVENTION

In the present invention, an electronically- controlled hammering module is used to apply a repetitive hammering force under electronic control to the top end of a penetrometer rod. In a preferred embodiment, the hammering module has a battery-powered percussive hammer that sits on top of the rod which, when activated, applies an electrically-generated impulse hammering force to the top of the rod. The hammering force is generated by electrically driving a small mass, e.g., of approximately 100 gm, at a controlled rate, e.g., of 5-50 Hz. The faster the rate of hammering, the more impact applied, so higher rates are used for stronger soils and lower rates for weaker soils. This application of force causes the cone-shaped point of the rod to penetrate into the soil at a controlled rate that is correlated with the strength of the soil. Therefore in this constant penetraton mode, the impact energy is correlated to the soil strength.

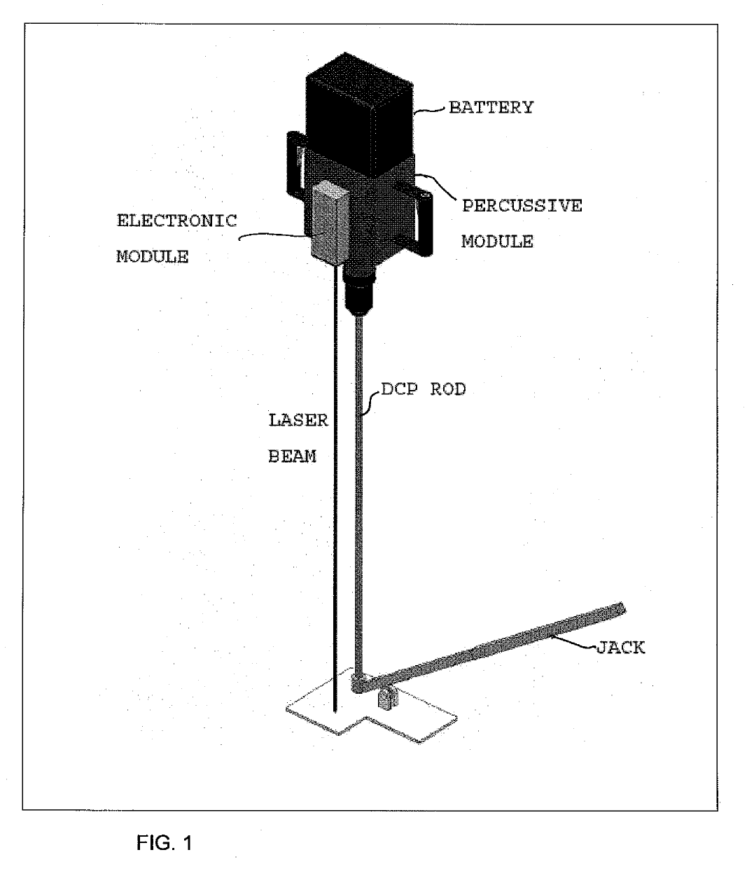

Other objects, features, and advantages of the present invention will be explained in the following detailed description of the invention having reference to the appended FIG. 1.

### DETAILED DESCRIPTION OF INVENTION

FIG. 1 shows a schematic perspective view of a penetrometer with an electronically-controlled hammering module in accordance with the present invention. The hammering module applies a controlled hammering force to the top of a driven end of a long, rigid rod having an opposite ground piercing end, referenced in the figure as a dynamic cone penetrometer (DCP) rod, to drive its ground-piercing end into the ground. In a preferred embodiment adapted for field use, the hammering module includes an electronic (control) module, a battery as a power source, and a percussive module for applying a controlled and repetitive percussive hammering force to the top of the rod. A jack is used to facilitate removal of the rod from the ground.

The application of the hammering force causes the cone-shaped point of the DCP rod to penetrate into the soil at a controlled rate that is correlated with the strength of the soil. The depth of penetration is determined by noting the decrease in distance between the initial height of the rod and its lower position as it descends into the ground. This distance is measured, for example, by a time-of-flight laser rangefinder (emitting a laser beam) that is mounted with the electronic module on the side of the percussive module and pointed at a suitable reflective surface placed on the ground adjacent to the location of penetration. Measurements from the laser rangefinder are transmitted by wire, or wirelessly, to a portable computer, where a software algorithm can compute the rate of penetration and in turn the soil strength profile. Control software will adjust the hammering rate to a level appropriate for the strength of the soil.

In the percussive module, the hammering force is generated by electrically driving a small mass at a controlled rate. For example, the mass can be of approximately 100 gm weight, and the rate of impulse driving can be of 5-50 Hz. The faster the rate of hammering, the more impact applied, so higher rates are used for stronger soils and lower rates for weaker soils. Thus, the rod can be driven into the soil with high frequency blows (in the range of 50 Hz) with low impulse energy (0.5-10 J).

The control software is adapted to read the depth data in real time and adjust the impulse of the hammering to keep the rate of penetration within a desired range, or to keep the rate of penetration constant. The software can consequently calculate, in real time, the penetration rate in blows per minute and compute the strength of the formation in California Bearing Ratio or some engineering property, such as soil resistance.

The automatically acquired depth measurements greatly reduce the amount of operator error and also speed up the determination of the soil's strength profile. The real-time penetration data are also used to instantly adjust the hammering energy to a level appropriate for the soil being tested, unlike the prior art, which requires a judgment determination and then several minutes to change from one hammer to another. Furthermore, the hammering energy can be made very small, to provide a more accurate correlation to CBR in weak soils than the prior types of DCP or ADCP hammers. The use of very small hammer impulses, which are controlled so as to maintain a constant rate of penetration, also confers on the invention the ability to measure actual engineering properties of the soil.

This invention has advantages over the prior types of penetrometers in that it is much easier to operate, requiring the user only to orient the unit upright such that the rod remains vertical, turn the unit on, and then maintain a light pressure to keep the unit vertical. Its operation does not require the user to have superior physical strength and does not result in user fatigue. Additionally, the risk of injury to the user is much lower because the hammering mechanism is not exposed. The improved penetrometer only employs three easily assembled components. It is lightweight and portable enough to be carried by a single person, even to remote locations. It can be operated by a single person, while the prior art devices can require two or more. Use of the improved penetrometer, including set up, operation, and break down, takes significantly less time than the prior art devices. Being an automated device, the action of hammering the rod into the ground is subject to automated control, resulting in more consistent soil strength data and also less time for each individual test.

Other modifications and variations may be made in accordance with the circumstances of field use for which the penetrometer is to be employed. The control software may be encoded in a simplified form for rugged use, e.g., as a stored look-up table in read-only memory ROM, that is embedded with the electronic (control) module rather than operated on a separate computer. This would be advantageous for highly mobile use by a single operator over far-ranging distances.

The hammer mechanism can be powered pneumatically or by internal combustion, rather than battery-powered. A heavier hammer, in the range of 500-1000 gm, can be made to impact with higher energy, but at a slower rate, e.g., 1-5 Hz. This embodiment is referred to as an Accelerated Cone Penetrometer (ACP). The rod that is driven into the soil may be made of other materials, for example, titanium alloy or aluminum alloy, and other penetration point configurations may be used.

The method of measuring the depth of penetration can be with any other non-contact method, such as an ultrasonic rangefinder, or it can be mechanical, making use of a wheel traveling along a guided track, or a string that is anchored to the ground and is retracted by a string as penetration proceeds.

Instead of keeping impact energy or impulse the same and controlling the rate of penetration, an alternative approach is to keep the penetration rate constant by changing the impulse or impact energy. In this method, the impact energy or impulse could be correlated to either an engineering soil property or a physical soil property.

Instead of keeping the rate of penetration the same (or within the certain range) by controlling the impact energy or impulse, an alternative approach is to keep the impact energy or impulse the same and record the rate of penetration (as is done with the DCP and ADCP). In this method, the penetration rate could be correlated to either an engineering soil property or a physical soil property.

While certain embodiments and improvements have been described above, it is understood that many other modifications and variations thereto may be devised given the above description of the principles of the invention. It is intended that all such modifications and variations be considered as within the spirit and scope of this invention, as defined in the following claims.

1. An improved penetrometer device comprising:
a long rigid rod having a driven end and an opposite, ground-piercing end for piercing into the ground; and
an electronically-controlled hammering module for generating a repetitive hammering force under electronic control that is applied to the driven end of the rod to drive the piercing end of the rod into the ground to a desired level.

2. An improved penetrometer device according to claim 1, wherein the rod is a dynamic cone penetrometer (DCP) rod having a cone-shaped point for penetrating into the ground.

3. An improved penetrometer device according to claim 1, wherein the hammering module includes an electronic (control) module, a battery as a power source, and a percussive module for applying a controlled and repetitive percussive hammering force to the top of the rod.

4. An improved penetrometer device according to claim 1, wherein the hammering module includes range-finding means for measuring the height of the top end of the rod from the ground as a measure of depth of penetration.

5. An improved penetrometer device according to claim 4, wherein the measure of depth of penetration into the ground is used to compute a rate of penetration that is correlated to the strength of the soil in the ground.

6. An improved penetrometer device according to claim 4, wherein the electronic module transmits signals from the range-finding means representing the depth of penetration into the ground by wire or wirelessly to a portable computer in order to compute the rate of penetration.

7. An improved penetrometer device according to claim 4, wherein the electronic module is embedded with computing means for receiving signals from the range-finding means representing the depth of penetration into the ground in order to compute the rate of penetration.

8. An improved penetrometer device according to claim 5 wherein the rate of penetration representing the soil strength profile is used to adjust the hammering rate of the hammering module to a level appropriate for the strength of the soil.

9. An improved penetrometer device according to claim 3, wherein the hammering force is generated by the percussive module by electrically driving a small mass at a controlled rate.

10. An improved penetrometer device according to claim 9, wherein the small mass is approximately 100 gm weight, and the rate of impulse driving is in the range of 5-50 Hz.

11. An improved penetrometer device according to claim 9, wherein for stronger soils, the rod is driven at a high rate in the range of 50 Hz with low impulse energy (0.5-10 J).

12. An improved penetrometer device according to claim 3, wherein the hammering force is generated by the percussive module having a hammer in the range of 500-1000 gm driven at a rate of 1-5 Hz.

13. An improved penetrometer device according to claim 1, wherein the hammering force is generated by the percussive module in which the rate of penetration of the rod into the ground is controlled by changing the impulse or impact energy.

14. An improved method of operating a penetrometer device having a long rigid rod with a driven end and an opposite, ground-piercing end for piercing into the ground, comprising:
generating a repetitive hammering force under electronic control that is applied to the driven end of the rod to drive the piercing end of the rod into the ground to a desired level.

15. An improved method of operating a penetrometer device according to claim 14, further including measuring the height of the top end of the rod from the ground as a measure of depth of penetration of the rod into the ground, and using the measure of depth of penetration into the ground to compute a rate of penetration that is correlated to the strength of the soil in the ground.

16. An improved method of operating a penetrometer device according to claim 15, wherein the rate of penetration representing the soil strength profile is used to adjust the hammering rate to a level appropriate for the strength of the soil.

17. An improved method of operating a penetrometer device according to claim 15, wherein the hammering force is generated by electrically driving a hammer of small mass of approximately 100 gm weight, and the rate of impulse driving is in the range of 5-50 Hz.

18. An improved method of operating a penetrometer device according to claim 15, wherein the hammering force is generated by electrically driving a hammer of larger mass of approximately 500 to 1000 gm weight, and the rate of impulse driving is in the range of 1-5 Hz.
